(19) United States
(12) Patent Application Publication
(10) Pub. No.: US 2011/0170808 A1
(43) Pub. Date: Jul. 14, 2011

(54) PLATFORM WITH AUTOMATIC LUBRICATION MECHANISM

(76) Inventor: Tung-Hsin CHEN, Taichung City (TW)

(21) Appl. No.: 12/686,592

(22) Filed: Jan. 13, 2010

(51) Int. Cl. F16C 33/10

(52) U.S. Cl. 384/13

(57) ABSTRACT

A platform with automatic lubrication mechanism. The platform includes at least one platform assembly. The platform assembly has at least two guide sections, at least two slide sections respectively slidably disposed on the guide sections, and at least two lubricating sections fixedly disposed on the guide sections. Each lubricating section has an internal cavity for containing therein a lubricant or the like, and an oil-filling passage extending from the cavity to the guide section to communicate with openings formed on one side of the guide section. Through the oil-filling passage, the cavity communicates with an exterior of the guide section. The slide section is movable to push a push member for making the lubricant or the like contained in the cavity spill out of the openings to provide lubrication effect between the guide section and the slide section.

### BACKGROUND OF THE INVENTION

The present invention relates generally to a linear motor, and more particularly to a platform with automatic lubrication mechanism.

FIG. 1 shows a conventional linear motor 1 having a mover 2 and a stator 3. The mover 2 is linearly reciprocally movable by means of the magnetic field effect between the mover 2 and the stator 3. The mover 2 is guided with linear guide rails 4 for controlling the linear track of the mover 2 and stabilizing the motion of the mover 2. The mover 2 is carried by sliders 5 slidably mounted on the slide rails 4, whereby the guide rails 4 can guide the mover 2 to reciprocally move.

To speak more specifically, ball bodies or rollers are held between the sliders 5 and the slide rails 4 to reduce frictional force so as to stabilize and smoothen the relative sliding motion of the sliders 5 along the slide rails 4. However, considerably great frictional force still exists between the ball bodies and the faces in contact with the ball bodies. Therefore, it is still necessary to lubricate the guide members.

FIG. 2 shows a conventional self-lubricating mechanism for lubricating the guide members. An oil reservoir 6 is connected with one side of the slider 5 for containing lubricating oil. The oil reservoir 6 has woolen felts 7 to provide capillary effect for feeding the lubricating oil reserved in the oil reservoir 6 between the ball bodies and the faces in contact therewith.

In normal use environment, such mechanism is able to achieve a certain lubricating effect. However, in a vacuum operation environment, the lubricating oil will have very high viscosity so that the capillary effect will be unapparent. Therefore, the guide members can be hardly lubricated with such self-lubricating mechanism in the vacuum operation environment. However, most of the production equipments for the current high-precision semiconductor products or plane displays require vacuum environment.

FIG. 3 shows a conventional pump-pressurized lubricating mechanism. By means of an external pressurizing pump 8, the lubricating oil is pumped into the slider 5 through an oil tube 9. The lubricating oil is then filled between the ball bodies and the faces in contact therewith. When using a linear motor in a vacuum operation environment, such mechanism is able to achieve the purpose of lubrication. However, in the vacuum environment, there is no medium so that the heat generated by the pressurizing pump 8 cannot be dissipated via air. Moreover, the pressurizing pump 8 is an additional component with respect to the linear motor, which will occupy much room and lead to increment of load. Accordingly, the pump-pressurized lubricating mechanism is not an optimal lubricating measure for the linear motor.

### SUMMARY OF THE INVENTION

It is therefore a primary object of the present invention to provide a platform with automatic lubrication mechanism, which can provide lubrication effect without using any additional power source so as to save energy.

It is a further object of the present invention to provide the above platform with automatic lubrication mechanism, which can be adaptively used in a vacuumed operation environment such as a vacuumed chamber to achieve reliable lubrication effect.

It is still a further object of the present invention to provide the above platform with automatic lubrication mechanism in which one single lubricating section can provide lubrication effect for more than one slide sections. Therefore, the load is reduced to save energy.

To achieve the above and other objects, the platform with automatic lubrication mechanism of the present invention includes at least one platform assembly. The platform assembly includes: at least one board-like platform section; at least two elongated guide sections fixedly disposed on an upper face of the platform section in parallel to each other; at least two lubricating sections without active power, the lubricating sections being disposed on platform section in adjacency to first ends of the guide sections respectively, each lubricating section having an internal cavity and a push member, a first end of the push member being slidably disposed in the cavity, a second end of the push member extending from one side of the cavity to an exterior of the cavity, the lubricating section further having an oil-filling passage, the oil-filling passage extending from another side of the cavity to an adjacent guide section to communicate with openings formed on one side of the guide section, whereby the cavity communicates with an exterior of the guide section via the oil-filling passage; and at least two slide sections respectively slidably disposed on the guide sections. The slide sections are drivable by a first external force to reciprocally lengthwise move along the guide sections. When the slide sections are driven by the first external force to move to first ends of the guide sections, end faces of the slide sections abut against the second ends of the adjacent push members. When the slide sections are further controllably moved to push the push members, the first ends of the push members sliding within the cavity to extrude a lubricant or the like contained in the cavity out of the cavity into the oil-filling passages. The lubricant then goes through the oil-filling passages to the openings formed on the guide sections and spilling out of the openings.

The present invention can be best understood through the following description and accompanying drawings, wherein:

### BRIEF DESCRIPTION OF THE DRAWINGS

FIG. 1 is a perspective exploded view of a conventional linear motor;

FIG. 2 shows a conventional self-lubricating mechanism;

FIG. 3 shows a conventional pumped lubrication mechanism;

FIG. 4 is a perspective view of a preferred embodiment of the present invention;

FIG. 5 is a sectional view of one of the lubricating sections of the preferred embodiment of the present invention;

FIG. 6 is a sectional view taken along line a-a of FIG. 4, showing the operation of the first platform assembly in one state;

FIG. 7 is a sectional view taken along line a-a of FIG. 4, showing the operation of the first platform assembly in another state; and

FIG. 8 is a sectional view taken along line b-b of FIG. 4, showing the operation of the second platform assembly.

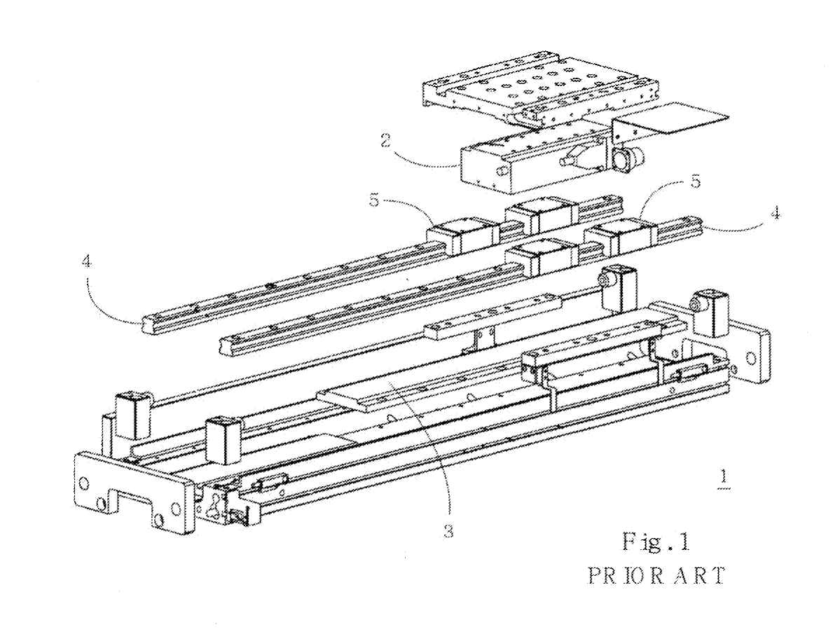

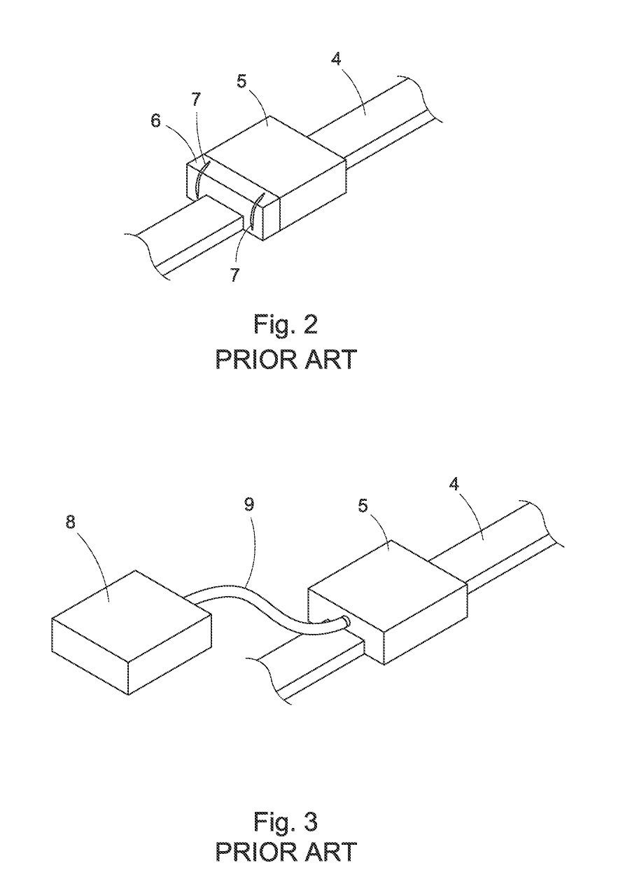

### DETAILED DESCRIPTION OF THE PREFERRED EMBODIMENT

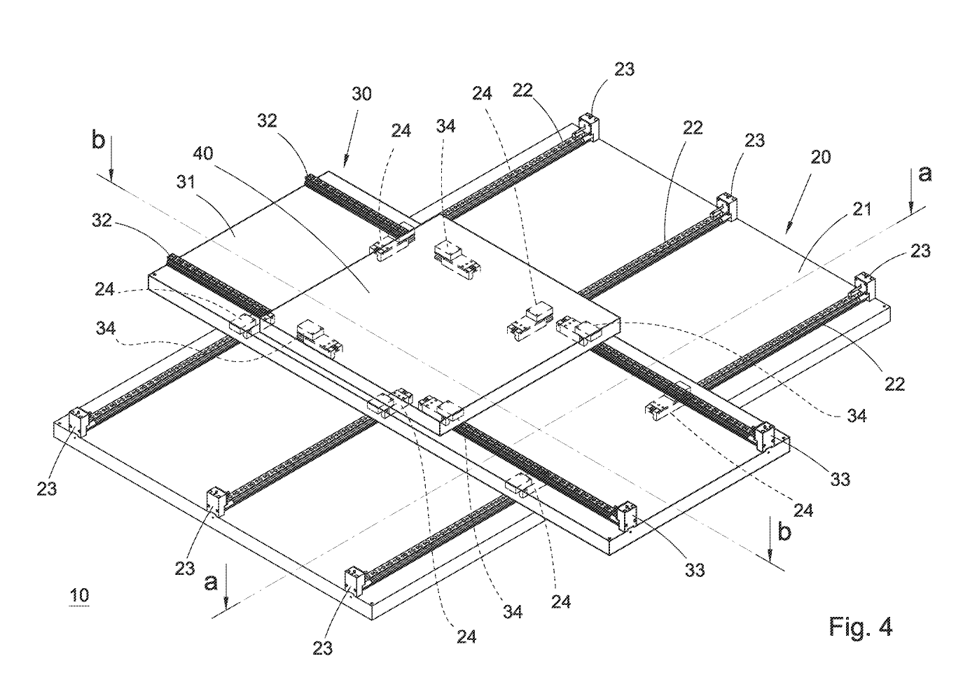

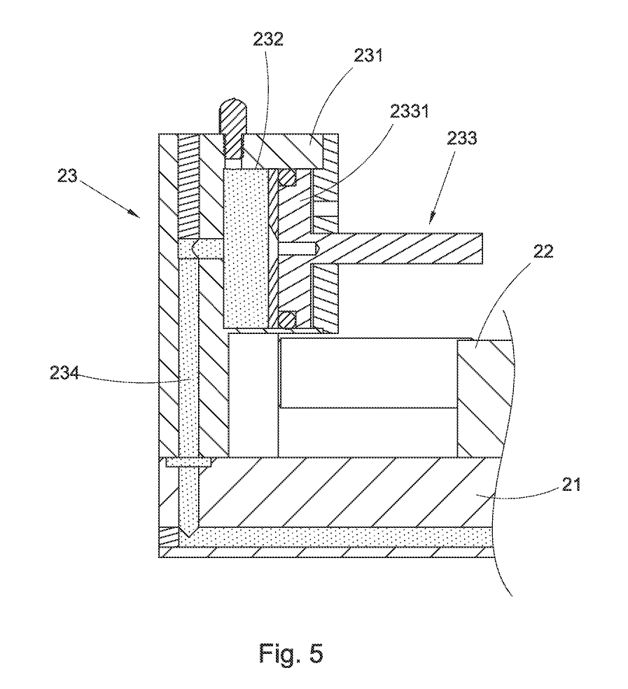

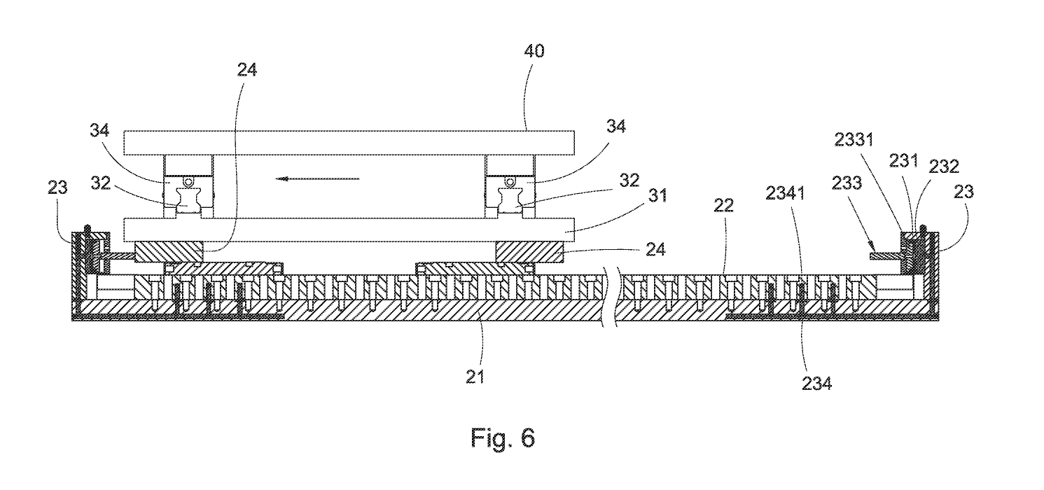

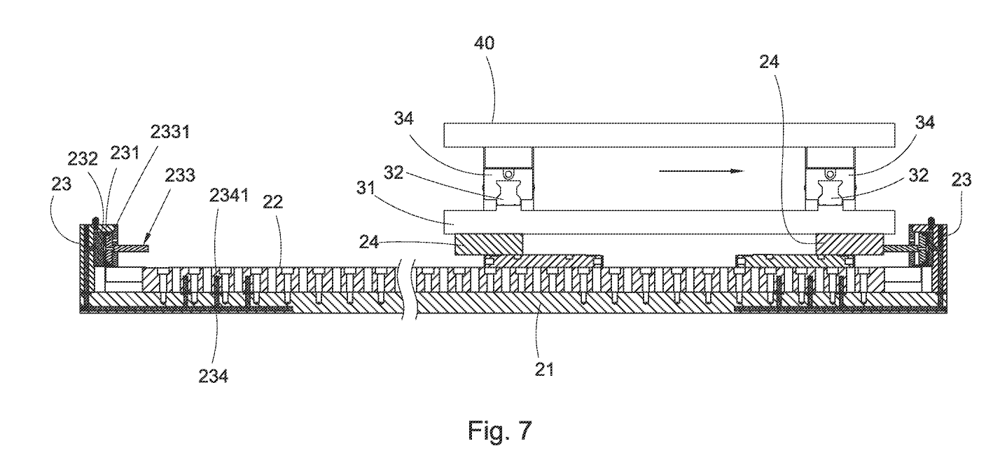

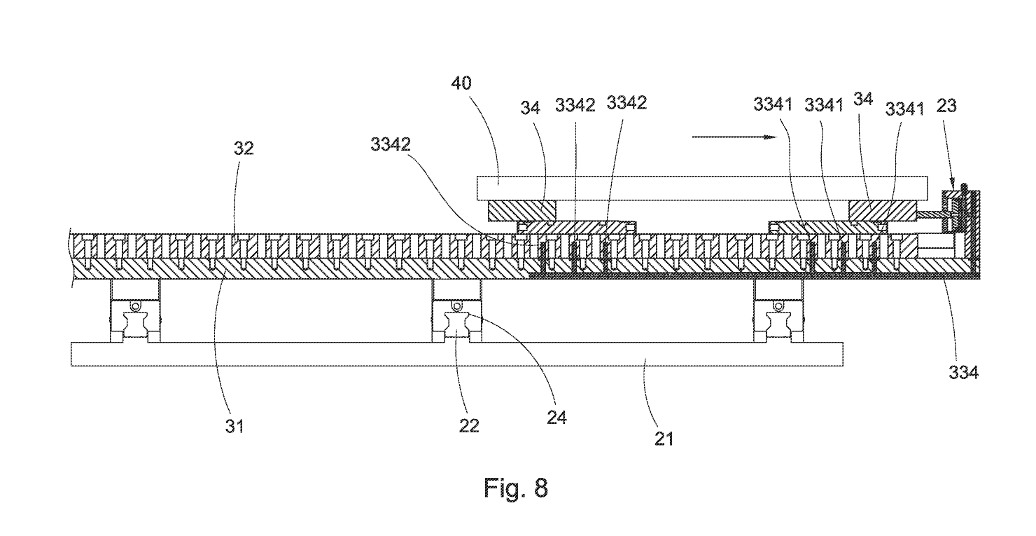

Please refer to FIGS. 4 to 7. According to a preferred embodiment, the platform 10 with automatic lubrication mechanism of the present invention includes a first platform assembly 20 and a second platform assembly 30. The first platform assembly 20 includes a rectangular board-like first platform section 21 with a certain thickness. The first platform section 21 is horizontally positioned as a base for a linear motor. Other components of the linear motor are arranged on the first platform section 21.

The first platform assembly 20 further includes three elongated first guide sections 22. The first guide sections 22 are fixedly disposed on an upper face of the first platform section 21 in parallel to the length of the rectangular first platform section 21.

The first platform assembly 20 further includes six first lubricating sections 23 without active power. The first lubricating sections 23 are fixedly disposed on the upper face of the first platform section 21 in adjacency to three first ends and three second ends of the first guide sections 22 respectively. To speak more specifically, each first lubricating section 23 has a main body 231 fixedly disposed on the first platform section 21. The main body 231 is formed with an internal cylindrical cavity 232. The first lubricating section 23 further has an elongated push member 233. The push member 233 has a large-diameter piston section 2331 as a first end and a small-diameter rod section as a second end. The piston section 2331 has a diameter approximately equal to that of the cavity 232 and is slidably disposed in the cavity 232. The rod section of the push member 233 extends from one side of the cavity 232 to an exterior of the main body 231 in a direction parallel to the length of the first platform section 21. The first lubricating section 23 further has an oil-filling passage 234. The oil-filling passage 234 extends from another side of the cavity 232 through the first platform section 21 to a corresponding first guide section 22 to communicate with several pairs of openings 2341 formed on two lateral sides of the first guide section 22. Accordingly, The cavity 232 communicates with an exterior of the first guide section 22 via the oil-filling passage 234.

The first platform assembly 20 further includes six first slide sections 24 respectively slidably disposed on the first guide sections 22 in pairs. The six first slide sections 24 are drivable by the same linear motor. The mover of the linear motor applies a first external force to the first slide sections 24 to make the first slide sections 24 reciprocally lengthwise move along the first guide sections 22.

According to the above arrangement, when lubrication is needed, the first slide sections 24 are driven to move to the first ends of the first guide sections 22. At this time, end faces of three first slide sections 24 adjacent to the first ends of the first guide sections 22 abut against free ends of the rod sections of the adjacent push members 233. Then, the first slide sections 24 are further controllably moved to push the push members 233, whereby the piston sections 2331 extrude the lubricant or the like contained in the cavity 232 out of the cavity 232 into the oil-filling passages 234. The lubricant then goes through the oil-filling passages 234 to the openings 2341 and spills out of the openings 2341 to achieve lubrication effect. The first slide sections 24 can move to the second ends of the first guide sections 22 to achieve the lubrication effect in the same manner.

The second platform assembly 30 includes a rectangular board-like second platform section 31 with a certain thickness. A bottom face of the second platform section 31 is attached to and fixedly disposed on upper faces of the first slide sections 24. The length of the rectangular second platform section 31 is perpendicular to the length of the rectangular first platform section 21. Accordingly, the second platform section 31 can be synchronously moved with the first slide sections 24.

The second platform assembly 30 further includes two elongated second guide sections 32. The second guide sections 32 are fixedly disposed on an upper face of the second platform section 31 in parallel to the length of the rectangular second platform section 31.

The second platform assembly 30 further includes two second lubricating sections 33 fixedly disposed on the upper face of the second platform section 31 in adjacency to first ends of the second guide sections 32 respectively. The second lubricating sections 33 are substantially identical to the first lubricating sections 23 in structure. The second lubricating sections 33 are only different from the first lubricating sections 23 in that the oil-filling passage 334 of each second lubricating section 33 has two sets of openings 3341, 3342 spaced from each other by a certain distance.

The second platform assembly 30 further includes four second slide sections 34 respectively slidably disposed on the second guide sections 32 in pairs. The four second slide sections 34 are drivable by the same linear motor. The mover of the linear motor applies a second external force to the second slide sections 34 to make the second slide sections 34 reciprocally move along the second guide sections 32. The two second slide sections 34 disposed on the same second guide section 32 are spaced by a distance approximately equal to the distance between the two sets of openings 3341, 3342. A movable platform 40 is mounted on and connected with the second slide sections 34, whereby the second slide sections 34 can be synchronously moved.

With respect to the second platform assembly 30, via the two sets of openings of each second lubricating section 33, the same second lubricating section 33 can provide lubrication effect between the two second slide sections 34 and the second guide section 32 on which the two second slide sections 34 are disposed. In comparison with the second lubricating section 33, the first lubricating section 23 of the first platform assembly 20 can provide lubrication effect between one single first slide sections 24 and the first guide section 22 on which the first slide section 24 is disposed.

According to the above arrangement, the lubricating sections of the platform 10 with automatic lubrication mechanism of the present invention can automatically provide lubrication effect by means of the original power of the linear motor. Therefore, the additional power source of the conventional device is saved. Moreover, in the second platform assembly 30, one single lubricating section can provide lubrication effect for more than one slide sections. Therefore, the load is reduced to save energy.

The above embodiment is only used to illustrate the present invention, not intended to limit the scope thereof. Many modifications of the above embodiment can be made without departing from the spirit of the present invention.

What is claimed is:

1. A platform with automatic lubrication mechanism, comprising at least one platform assembly, the platform assembly including:
at least one board-like platform section;
at least two elongated guide sections fixedly disposed on an upper face of the platform section in parallel to each other;
at least two lubricating sections without active power, the lubricating sections being disposed on platform section in adjacency to first ends of the guide sections respectively, each lubricating section having an internal cavity and a push member, a first end of the push member being slidably disposed in the cavity, a second end of the push member extending from one side of the cavity to an exterior of the cavity, the lubricating section further having an oil-filling passage, the oil-filling passage extending from another side of the cavity to an adjacent guide section to communicate with openings formed on one side of the guide section, whereby the cavity communicates with an exterior of the guide section via the oil-filling passage; and
at least two slide sections respectively slidably disposed on the guide sections, the slide sections being drivable by a first external force to reciprocally lengthwise move along the guide sections, whereby when the slide sections are driven by the first external force to move to first ends of the guide sections, end faces of the slide sections abut against the second ends of the adjacent push members, when the slide sections are further controllably moved to push the push members, the first ends of the push members sliding within the cavity to extrude a lubricant or the like contained in the cavity out of the cavity into the oil-filling passages, the lubricant then going through the oil-filling passages to the openings formed on the guide sections and spilling out of the openings.

2. The platform with automatic lubrication mechanism as claimed in claim 1, wherein the number of the lubricating sections is four, the four lubricating sections being arranged in pairs in adjacency to the first ends and second ends of the guide sections respectively, the number of the slide sections being also four, the four slide sections being respectively slidably disposed on the guide sections in pairs, the four slide sections being drivable by the first external force to synchronously slide along the slide sections, whereby when the slide sections are moved to the first ends of the guide sections, the end faces of the slide sections adjacent to the first ends of the guide sections abut against the second ends of the adjacent push members to push the push members, and when the slide sections are moved to the second ends of the guide sections, end faces of the slide sections adjacent to the second ends of the guide sections abut against the second ends of the adjacent push members to push the push members.

3. The platform with automatic lubrication mechanism as claimed in claim 1, wherein the number of the slide sections is four, the four slide sections being respectively slidably disposed on the guide sections in pairs and drivable by the first external force, the two slide sections disposed on the same guide section being spaced from each other by a predetermined distance, the oil-filling passage of each lubricating section having at least two openings formed on one side of the adjacent guide section, the two openings being spaced from each other by a distance approximately equal to the predetermined distance, whereby the lubricant or the like can spill from the openings to where the slide sections are positioned.

4. The platform with automatic lubrication mechanism as claimed in claim 1, wherein the number of the platform assemblies is two, a bottom face of the platform section of a second platform assembly being attached to upper faces of the slide sections of a first platform assembly, whereby the platform section of the second platform assembly is slidably disposed on the first platform assembly.

5. The platform with automatic lubrication mechanism as claimed in claim 4, wherein the number of the lubricating sections of the first platform assembly is four, the four lubricating sections being arranged in pairs in adjacency to the first ends and second ends of the guide sections respectively, the number of the slide sections of the first platform assembly being also four, the four slide sections being respectively slidably disposed on the guide sections in pairs, the four slide sections being drivable by the first external force to synchronously slide along the slide sections, whereby when the slide sections are moved to the first ends of the guide sections, the end faces of the slide sections adjacent to the first ends of the guide sections abut against the second ends of the adjacent push members to push the push members, and when the slide sections are moved to the second ends of the guide sections, end faces of the slide sections adjacent to the second ends of the guide sections abut against the second ends of the adjacent push members to push the push members.

6. The platform with automatic lubrication mechanism as claimed in claim 5, wherein the number of the slide sections of the second platform assembly is four, the four slide sections being respectively slidably disposed on the guide sections in pairs and drivable by a second external force, the two slide sections disposed on the same guide section being spaced from each other by a predetermined distance, the oil-filling passage of each lubricating section having at least two openings formed on one side of the adjacent guide section, the two openings being spaced from each other by a distance approximately equal to the predetermined distance, whereby the lubricant or the like can spill from the openings to where the slide sections are positioned.

7. The platform with automatic lubrication mechanism as claimed in claim 4, wherein the guide sections of the second platform assembly have a length perpendicular to that of the guide sections of the first platform assembly.
